(19) United States
(12) Patent Application Publication
(10) Pub. No.: US 2025/0356683 A1
(43) Pub. Date: Nov. 20, 2025

(54) Gating UI Invocation Based on Pinch Gap and Index Finger Occlusion

(71) Applicant: Apple Inc., Cupertino, CA (US)

(72) Inventor: Chase B. Lortie, San Francisco, CA (US)

(21) Appl. No.: 19/177,308

(22) Filed: Apr. 11, 2025

Related U.S. Application Data
(60) Provisional application No. 63/649,066, filed on May 17, 2024.

(51) Int. Cl. G06V 40/10; G06F 3/01; G06F 3/0488; G06V 10/26; G06V 40/18; G06V 40/20

(52) U.S. Cl. CPC G06V 40/11; G06F 3/013; G06F 3/0488; G06V 10/26; G06V 40/18; G06V 40/28

(57) ABSTRACT

Enabling gesture recognition and input based on hand tracking data and occlusion information is described. Hand tracking data is obtained of a hand performing an input gesture while the hand is in a first interface state. The technique includes determining pinch gap characteristics and occlusion characteristics of the index finger. A hand is determined to either be in an object-occlusion detection state or an object-occlusion un-detection state based on the occlusion characteristics of the index finger and the first interface state. A gesture signal is adjusted to affect an action corresponding to the input gesture based on whether the hand is determined to be in the object-occlusion detection state or the object-occlusion un-detection state.

### BACKGROUND

In the realm of extended reality (XR), hand gestures are becoming an increasingly intuitive method for user input, offering a seamless way to interact with virtual environments. Hand tracking technologies allow users to perform a variety of gestures that the system can recognize and interpret as commands. For instance, a pinch could be used to select an object, while a swipe motion might navigate through menus or rotate a 3D model. Some systems allow for more complex gestures, like using sign language to input text or control actions within the virtual space. This hands-free approach not only enhances the immersive experience but also provides a natural and ergonomic way to interact, reducing the reliance on physical controllers. As XR technologies evolve, the potential for hand gesture input is expanding, promising more sophisticated and responsive interfaces that cater to a wide range of applications and user preferences. However, what is needed is an improved technique to improve the detection of an input gesture from a hand pose, and detect unintentional hand gestures.

### BRIEF DESCRIPTION OF THE DRAWINGS

FIGS. 1A-1B show example diagrams of a user performing a hand pose, in accordance with one or more embodiments.

FIG. 2 shows a flowchart of a technique for activation user interface components, in accordance with some embodiments.

FIG. 3 shows a flowchart of a technique for determining pinch gap visibility, in accordance with one or more embodiments.

FIG. 4A, 4B, and 4C depict example diagrams of hand tracking data from which pinch gap visibility and index joint occlusion can be determined in accordance with one or more embodiments.

FIGS. 5 show an example diagram of a user performing an alternate hand pose, in accordance with one or more embodiments.

FIGS. 6A, 6B, and 6C depict example diagrams of hand tracking data from which pinch gap visibility is determined, in accordance with one or more embodiments.

FIG. 7 depicts an example state machine for determining object-occlusion detection state, in accordance with one or more embodiments.

FIGS. 8A-8B depict flowcharts of techniques for transitioning between an object-occlusion detection state and an object-occlusion un-detection state, in accordance with one or more embodiments.

FIG. 9 depicts a flowchart of an example technique for determining index finger joint occlusion, in accordance with one or more embodiments.

FIG. 10 depicts a flowchart of the example technique for determining hand pose reliability, in accordance with more one or more embodiments.

FIG. 11 shows a flowchart of a technique for determining whether the hand is in an input pose, in accordance with some embodiments.

FIG. 12A shows a flowchart of a technique for determining whether a gaze criterion is satisfied, in accordance with one or more embodiments.

FIG. 12B shows a diagram of gaze targets, in accordance with one or more embodiments.

FIG. 13 shows a system diagram of an electronic device which can be used for gesture input, in accordance with one or more embodiments.

FIG. 14 shows an exemplary system for use in various extended reality technologies.

### DETAILED DESCRIPTION

This disclosure pertains to systems, methods, and computer readable media to enable gesture recognition and input. In some enhanced reality contexts, image data and/or other sensor data can be used to detect gestures by tracking hand data. For example, hand joints may be tracked to determine whether a hand is performing a pose associated with an input gesture. However, when a hand is holding an object, the position of the joints may appear to be performing an input gesture, particularly with input gestures that require a palm up or palm down position. Thus, techniques described herein prevent the accidental activation of an input action associated with an input gesture when the user's hand is holding an object, in particular because of a prediction of whether a hand is occluded by an object or is self-occluded based on visibility of a pinch gap and occlusion characteristics of an index finger.

Techniques described herein are used to determine whether a hand in a pose that corresponds to a user input pose is intentionally performing the user input pose to affect user interface activation. In particular, techniques described herein provide a multi-step process to efficiently predict whether a pose should be processed as a user input gesture. In some embodiments, a relationship between a thumb and an index finger may be analyzed to determine whether a pinch gap is visible to a camera. The visibility of the pinch gap may provide visual context as to whether a user is intended to perform a palm up position or palm down position or not. The pinch gap may be visible, for example, if a distance between the index finger and thumb satisfy a threshold distance, and/or if the index finger and thumb are arranged such that the thumb is outside the index finger. In some embodiments, a determination that the gap distance is not visible may cause user interface activation to be blocked without further requiring any determination or analysis of occlusion values of the index finger. This allows the system to filter out hand poses in which a user may be pinching or holding small objects such that a gap distance between the thumb and index finger is small. By considering the arrangement of the thumb and index finger, the system can filter out hand poses which indicate the user is holding something in their hand without requiring additional analysis.

In some embodiments, the prediction of whether a hand is performing an input gesture may include predicting whether a hand or portion of a hand is occluded by a physical object (for example, a physical object being held by the hand), or if the hand is self-occluded. A hand may be self-occluded, for example, if the fingers are in a curled position such that the fingers are blocking a view of a portion of the hand. In some embodiments, hand tracking techniques provide hand tracking data based on characteristics of different portions of the hands, such as joints in the hand.

The techniques described herein leverage state information for a user input component to reduce the complexity of hand tracking signals used to predict whether an input gesture is intentionally performed. For example, to transition from predicting that the hand is self-occluded to predicting that the hand is occluded by an object, a determination of non-self-occluded joints of the index finger may be made, and the corresponding occlusion values may be analyzed to determine whether the occlusion values satisfy an occlusion threshold. By contrast, to transition from predicting that the hand is occluded by an object to determining that the hand is self-occluded, occlusion values for the index fingers may be compared against a visibility threshold, regardless of any determination of whether the individual joints are self-occluded, thereby reducing the complexity of the algorithm.

Embodiments described herein provide an efficient manner for determining whether a user is performing a palm up input gesture using hand tracking data by reducing accidental input gestures caused by a hand being occupied or otherwise occluded by a physical object. Further, embodiments described herein improve upon input gesture detection techniques by considering the pose of the hand along with occlusion scores to further infer whether a hand is occluded by an object without performing object detection on the object in the hand, thereby improving usefulness of gesture-based input systems.

In the following disclosure, a physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an XR environment refers to a wholly or partially simulated environment that people sense and/or interact with via an electronic device. For example, the XR environment may include Augmented Reality (AR) content, Mixed Reality (MR) content, Virtual Reality (VR) content, and/or the like. With an XR system, a subset of a person's physical motions, or representations are tracked, and in response, one or more characteristics of one or more virtual objects simulated in the XR environment, are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include: head-mountable systems, projection-based systems, heads-up displays (HUD), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mountable system may have one or more speaker(s) and an integrated opaque display. Alternatively, a head-mountable system may be configured to accept an external opaque display (e.g., a smartphone). The head-mountable system may incorporate one or more imaging sensors to capture images or video of the physical environment, and/or one or more microphones to capture audio of the physical environment. Rather than an opaque display, a head-mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

In the following description, for purposes of explanation, numerous specific details are set forth in order to provide a thorough understanding of the disclosed concepts. As part of this description, some of this disclosure's drawings represent structures and devices in block diagram form in order to avoid obscuring the novel aspects of the disclosed concepts. In the interest of clarity, not all features of an actual implementation may be described. Further, as part of this description, some of this disclosure's drawings may be provided in the form of flowcharts. The boxes in any particular flowchart may be presented in a particular order. It should be understood, however, that the particular sequence of any given flowchart is used only to exemplify one embodiment. In other embodiments, any of the various elements depicted in the flowchart may be deleted, or the illustrated sequence of operations may be performed in a different order, or even concurrently. In addition, other embodiments may include additional steps not depicted as part of the flowchart. Moreover, the language used in this disclosure has been principally selected for readability and instructional purposes and may not have been selected to delineate or circumscribe the inventive subject matter, or resort to the claims being necessary to determine such inventive subject matter. Reference in this disclosure to “one embodiment” or to “an embodiment” means that a particular feature, structure, or characteristic described in connection with the embodiment is included in at least one embodiment of the disclosed subject matter, and multiple references to “one embodiment” or “an embodiment” should not be understood as necessarily all referring to the same embodiment.

It will be appreciated that in the development of any actual implementation (as in any software and/or hardware development project), numerous decisions must be made to achieve a developer's specific goals (e.g., compliance with system-and business-related constraints) and that these goals may vary from one implementation to another. It will also be appreciated that such development efforts might be complex and time-consuming but would nevertheless be a routine undertaking for those of ordinary skill in the design and implementation of graphics modeling systems having the benefit of this disclosure.

For purposes of this application, the term “hand pose” refers to a position and/or orientation of a hand.

For purposes of this application, the term “input gesture” refers to a hand pose or motion which, when detected, triggers a user input action.

### Using Hand Tracking Data to Activate UI Components

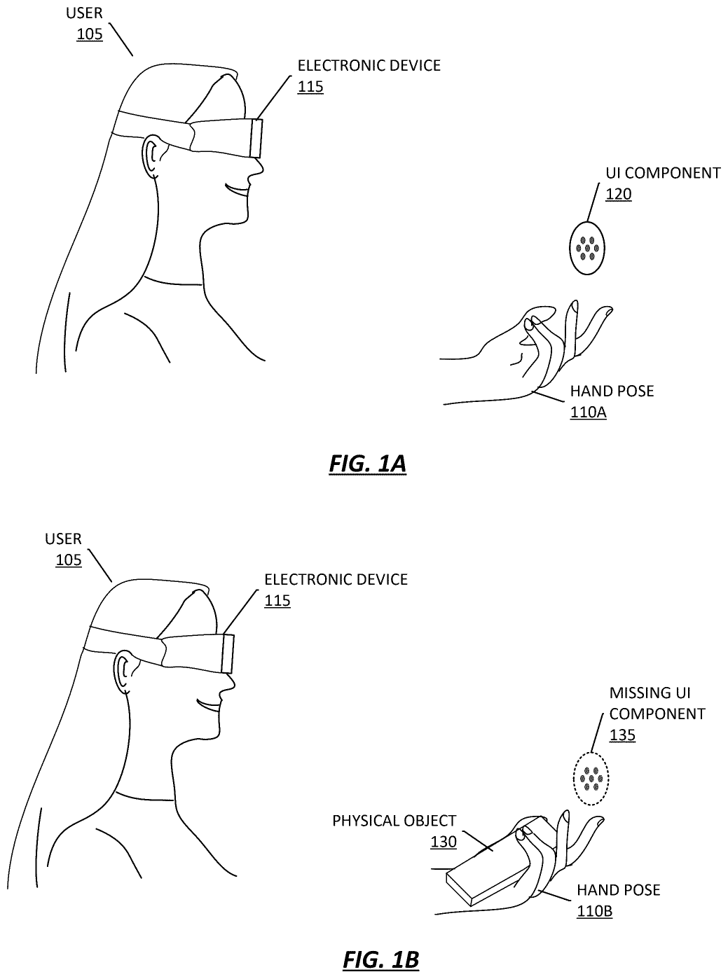

FIGS. 1A-1B show example diagrams of a user performing a first input gesture, in accordance with one or more embodiments. In particular, FIG. 1A shows a user 105 using an electronic device 115 within a physical environment. According to some embodiments, electronic device 115 may be a head mounted device such as goggles or glasses, and may optionally include a pass-through or see-through display such that components of the physical environment are visible. In some embodiments, electronic device 115 may include one or more sensors configured to track the user to determine whether a pose of the user should be processed as user input. For example, electronic device 115 may include outward-facing sensors such as cameras, depth sensors, and the like, which may capture one or more portions of the user, such as hands, arms, shoulders, and the like. Further, in some embodiments, the electronic device 115 may include inward-facing sensors, such as eye tracking cameras, which may be used in conjunction with the outward-facing sensors to determine whether a user input gesture is performed.

Certain hand positions or gestures may be associated with user input actions. In the example shown, user 105 has their hand in hand pose 110A, in a palm-up position. In some embodiments, the hand pose 110A may be determined to be a palm-up input pose based on a geometry of tracked portions of the hand, such as joints in the hand. For example, the geometric characteristics of the arrangement of joints in the hand can be analyzed to determine whether the hand is performing a user input gesture.

For purposes of the example, the palm-up position may be associated with a user input action to cause user interface (UI) component 120 to be presented. According to one or more embodiments, UI component 120 may be virtual content which is not actually present in the physical environment, but is presented by electronic device 115 is an extended reality context such that UI component 120 appears within physical environment from the perspective of user 105. Virtual content may include, for example, graphical content, image data, or other content for presentation to a user.

Because hand tracking relies on the position and geometric characteristics of the different portions of the hand, input gestures may be detected when they are performed unintentionally, such as when a person performs a hand pose in the context of interacting with an object. As shown in FIG. 1B, the user 105 is performing the same hand pose 110B. However, hand pose 110B shows a hand holding a physical object 130. Thus, an analysis of the geometry of tracked portions of the hand, such as joints in the hand, may lead to a determination that the hand pose 110B corresponds to a palm-up input gesture, as was determined by hand pose 110A of FIG. 1A. However, because the hand pose 110B of FIG. 1B is performed while the user is holding the physical object 130, the input gesture is likely unintentional. Thus, the invocation of the UI component associated with the gesture will be blocked, as shown by missing UI component 135.

Notably, hand pose 110A of FIG. 1A and hand pose 110B of FIG. 1B both show ring and pinky fingers curled over the hand so as to obstruct the palm from the perspective of the electronic device 115. However, hand pose 110A shows the ring finger and pinky finger curled as part of the natural pose of the palm-up position, whereas hand pose 110B of FIG. 1B shows the pinky and ring fingers curled because they are holding physical object 130. Accordingly, techniques described herein provide the capability of differentiating between occlusions caused by the hand pose causing portions of the hand to be self-occluded, and occlusion caused by the presence of physical objects in or near the hand, without relying on object detection. By differentiating between the type of occlusion, UI invocation or other user input actions may be gated when the hand is occupied, thereby reducing the likelihood of unintentional input actions being invoked by a hand pose.

In particular, techniques described herein rely on characteristics of the pose and contextual information regarding a current UI state and/or occlusion determination state of the hand to determine whether a user input action should be activated, ignored, blocked, or dismissed. According to one or more embodiments, a gap distance visibility between a thumb and index finger may be used to reject gestures activating a user interface component when the gap distance is not visible from a camera capturing the hand. If the gap distance is visible, then additional parameters are considered, such as index finger occlusion characteristics, user interface state, and the like.

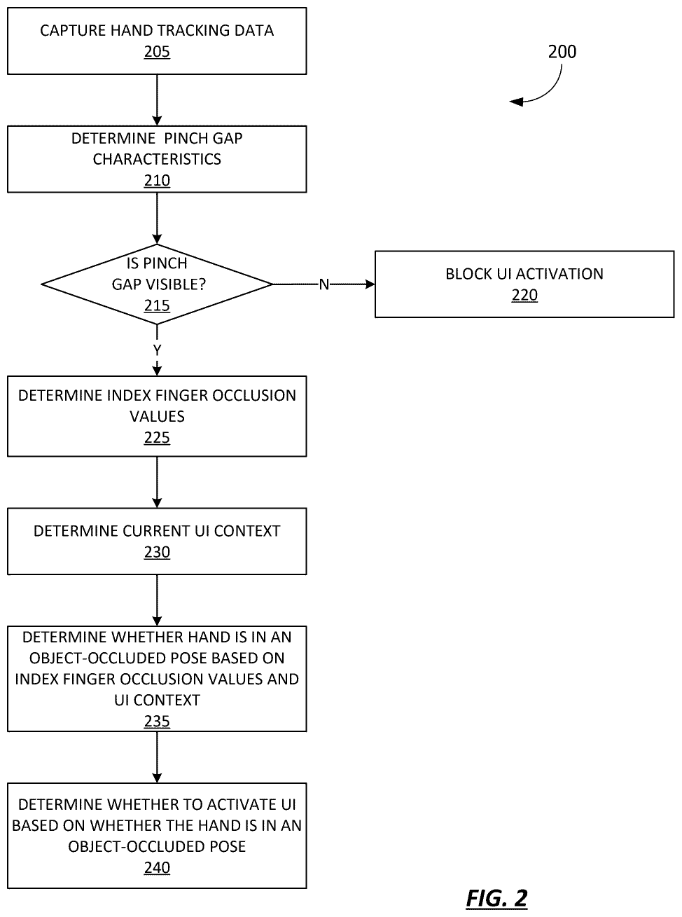

Generally, techniques described herein are related to a technique for adjusting how and input gesture is processed based on a determination of the intentionality of the gesture, which is inferred from hand tracking data, occlusion data, user interface context, and the like. In particular, techniques described herein use a process to filter our poses which are determined to be unrelated to intentional user interface gestures, particular when the gesture involves a palm-up position. FIG. 2 shows a flowchart of a technique for activation user interface components, in accordance with some embodiments. For purposes of explanation, the following steps will be described as being performed by particular components. However, it should be understood that the various actions may be performed by alternate components. The various actions may be performed in a different order. Further, some actions may be performed simultaneously, and some may not be required, or others may be added.

The flowchart 200 begins to block 205, where hand tracking data is captured. According to one or more embodiments, the hand tracking data may include image data, depth data, and/or other sensor data. The hand tracking data may be obtained from one or more cameras, including stereoscopic cameras or the like. In some embodiments, the hand tracking data may include sensor data captured by outward facing cameras of a head mounted device. The hand tracking data may be obtained by applying the captured sensor data to a hand tracking network or another source which generates hand tracking data from camera or other sensor data.

The flowchart 200 proceeds to block 210, where pinch gap characteristics are determined. According to one or more embodiments, the pinch gap may represent space between a thumb tip and index finger bone, and the pinch gap characteristics may include position and location information of portions of the thumb and index finger. At block 215, a determination is made as to a visibility of the pinch gap. Pinch gap visibility may indicate whether a threshold distance between the thumb tip and the index finger bone is visible from the perspective of one or more of the cameras capturing the image data of the hand used for hand tracking, and whether the thumb is outside the hand.

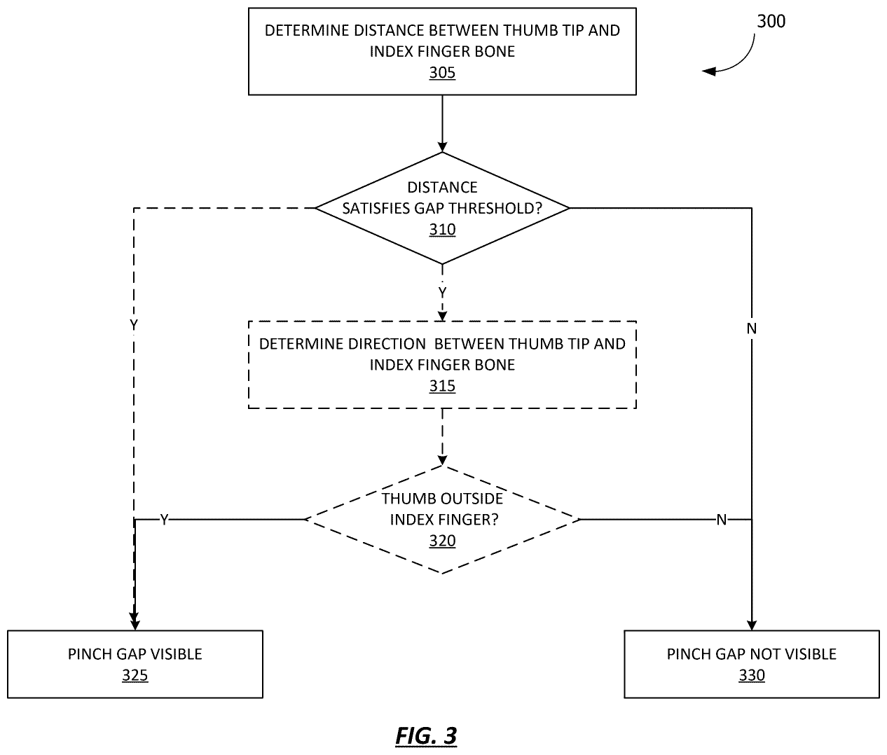

Turning to FIG. 3, a flowchart of a technique for determining pinch gap visibility, in accordance with one or more embodiments. The flowchart 300 begins at block 305, where a distance between a thumb tip and an index finger bone is determined. According to one or more embodiments, the distance may indicate how much space is visible to the user's eye from the thumb tip to the index finger bone. In some embodiments, the distance may be based on a perpendicular projection vector from a hover vector originating at the thumb tip and directed to the index fingertip, projected onto eye space, visible to the user.

The flowchart 300 proceeds to block 310 where a determination is made as to whether the distance satisfies a gap threshold. In some embodiments, the gap threshold may be a minimum distance between the thumb tip and fingertip index to determine that the thumb and fingertip are not in a pinching position or otherwise touching or near each other. For example, a hand may be facing up, but a user may be performing the pose as they are naturally moving their hands in a manner such that the index and thumbs are pinched, when they are interacting with small objects, or the like. Thus, a sufficiently small gap distance may indicate that a palm-up input gesture is unintentional. Accordingly, at block 310, if the distance does not satisfy a gap threshold, then the flowchart 300 concludes at block 330 and the pinch gap is determined to be not visible.

Returning to FIG. 3, if the gap distance is determined satisfy the gap threshold at block 310, then the flowchart continues to block 315. At block 315, a determination is made as to a direction between the thumb tip and index finger bone. In particular, a determination is made as to whether the thumb is inside the index finger, such that the thumb is overlaying the palm, or if the thumb is outside the index finger. Then, at block 320, a determination may be made as to whether the thumb is outside the index finger. If the thumb is not outside the index finger, then the flowchart concludes at block 330, and the pinch gap is not considered to be visible. Alternatively, if at block 320, the thumb is determined to be outside the index finger, then the flowchart concludes at block 325, and the pinch gap is determined to be visible.

In an alternate embodiment, at block 305, the orientation of the index and the thumb may be determined as part of the gap distance. This may occur, for example, by considering a potential positive and negative gap distance, where a negative gap distance is when the thumb is inside the index finger such that the thumb is overlaying the palm, whereas a positive gap distance is determined when the thumb is outside the index finger. As such, determining whether the distance satisfies a gap threshold may additionally include determining whether the gap distance is a positive gap distance. Thus, a negative gap distance would be determined to fail to satisfy the gap threshold at decision block 310, and the flowchart could conclude at block 330, where the pinch gap is determined to be not visible. Alternatively, a determination at block 310 that the gap distance satisfies the threshold gap distance (and, thus, is inherently a positive gap distance), the flowchart concludes at block 325, and the gap distance is determined to be visible.

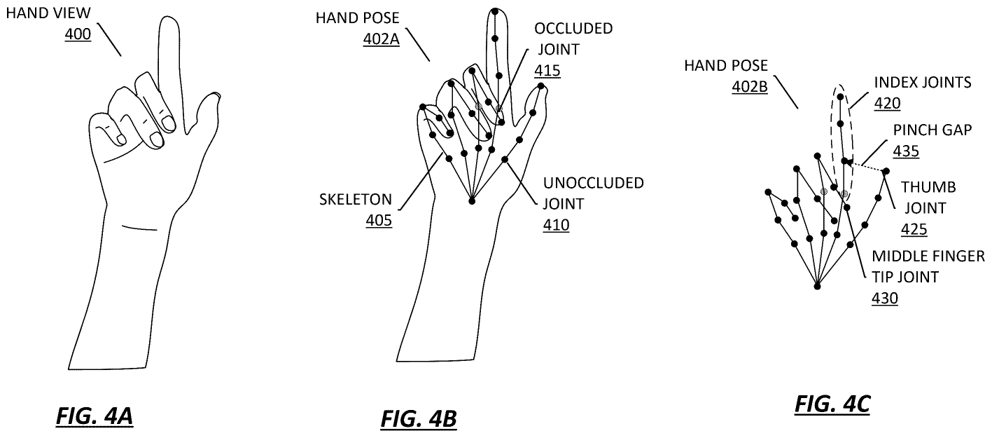

In some embodiments, a hand tracking procedure may be performed concurrently with the gesture detection process described here in the period and some embodiments, the hand tracking procedure may provide characteristics of joints of the hand. These characteristics may include, for example, position information, location information, rotation information, occlusion values, and the like. FIGS. 4A, 4B, and 4C depict example diagrams of hand tracking data from which pinch gap visibility and index joint occlusion can be determined in accordance with one or more embodiments. In particular, FIGS. 4A, 4B, and 4C depict example hand tracking data of a hard performing a pose similar to the pose shown above with respect to FIG. 1A-1B. The hand view in FIG. 4A shows a view of a hand 400 as it may be captured by a camera, such as a camera of an image capture system of an electronic device. According to one or more embodiments, the view of the hand 400 may be captured from an electronic device from a perspective of the user, such as a head mounted device or other wearable device having an image capture system, or other image capture device positioned such that the hand view can be captured.

According to some embodiments, hand tracking data may be captured for different portions of the hand in order to identify the hand pose or other characteristics of the hand. FIG. 4B shows a diagram of example hand tracking data in the form of a skeleton 405. The skeleton 405 may include a collection of joints tracked by a hand tracking system. In some embodiments, the hand tracking system may determine location information for each joint in the hand. In some embodiments, hand pose 402A may be determined based on geometric characteristics of the skeleton 405.

According to one or more embodiments, the hand tracking system may provide an occlusion score for each joint in the hand. The occlusion score may indicate whether the portion of the hand corresponding to the particular joint (i.e., a portion of the surface of the hand corresponding to the particular joint) is visible from the point of view of the camera. In the example shown, occluded joint 415 is a joint in a palm at the base of the index finger that is occluded by the upper portion of the middle finger, and is represented by a gray circle. Unoccluded joint 410A represents a joint toward the top of the index finger, which is not occluded, and is represented by a black circle. In some embodiments, the image capture system may include a stereo camera or other multi camera system, in which at least some hand tracking data may be determined for each camera. For example, an occlusion score may be determined for each camera because whether the joint location is occluded will differ based on the camera position of each camera, whereas location information may be determined for each camera, or may be determined based on the combination of image data captured from the cameras. The occlusion score may be a Boolean value indicating whether or not the joint is occluded, or may be a value indicating a confidence value that the joint is occluded, or representing how occluded the joint is, such as when the joint is partially occluded.

In determining whether a hand is in an object-occluded pose, occlusion information for a subset of the joints may be considered. As shown in FIG. 4C, hand pose 402B is shown with a subset of the joints from skeleton 405 from FIG. 4B. In the example shown in FIG. 4C, occlusion values for the index joints 420 are considered in determining whether a hand is in an object-occluded pose. According to one or more embodiments, index joints 420 may be a collection of hand joints that comprise the index joint, for example from a base of the index finger to the fingertip of the index finger. Here, the occluded joint 415 remains under consideration because it belongs to the index joints 420, while the unoccluded joint 410A is not considered, as it belongs to the thumb. Notably, because occlusion information can be obtained for each camera capturing the hand, while occluded joint 415 is determined to be occluded in this view, if the hand pose 402B is captured by a stereo camera system, the occluded joint 415 may not be occluded from the perspective of an alternative camera. The occluded joint 415A is occluded by the middle fingertip joint 430.

The gap distance 435 represents the distance between thumb joint 425 and the index finger. For example, the gap distance 435 may be determined based on a distance between the thumb joint 425 at the tip of the thumb and one of the index joints 420. Alternatively, the gap distance 435 may be determined based on a distance between the thumb joint 425 and a bone of the index finger, which may be derived from the index joints 420. As described above, in some embodiments, the pinch gap is determined to be visible by projecting the perpendicular projection vector from the hover vector (between the thumb tip and index fingertip) onto the camera plane. Thus, the visibility is determined from the point of view of the camera. Here, because the gap distance 435 is fairly large, and the thumb is outside the index finger, the gap distance may be determined to be visible.

Returning to FIG. 2, if at block 215 a determination is made that the pinch gap is visible, then the flowchart 200 proceeds to block 225, and index finger occlusion values are determined. At block 225, occlusion values corresponding to the index finger are obtained. This may include, for example, occlusion values corresponding to each joint of the index finger, or otherwise one or more values for an index region finger of the hand. In the example of FIG. 4, this may include the occlusion values for index joints 420.

The flowchart 200 of FIG. 2 proceeds to block 230, where a current UI context is determined. In some embodiments, the palm up position may be associated with one or more user interface components which may be revealed or dismissed based on characteristics of the hand gesture. Accordingly, the current UI context may relate to a determination as to whether the one or more user interface components are currently active or inactive. This may include, for example, determination as to whether the one or more UI components are currently being presented in the extended reality environment.

At block 235, a determination is made as to whether the hand is in an object occluded pose based on the index finger occlusion values and the UI context. Generally, an object occluded pose may indicate that, based on the index finger occlusion values and the UI context, a prediction can be made that the user is not intending to perform an input gesture, for example because the pose is predicted to be associated with the user's hand interacting with the physical object. Accordingly, the object included pose may be determined without detecting a physical object in the hand, and may be predicted based on hand tracking data and user interface context.

The flowchart 200 concludes at block 240, where the system determines whether to activate one or more UI components based on whether the hand is determined to be in an object-occluded pose. In some embodiments, if the hand is determined to be in an object-occluded pose, a gesture signal maybe ignored or discarded. Alternatively, as will be described in greater detail below, more complex decision making may be made as to whether to allow a gesture signal, or adjust a current gesture signal, based on current context.

Returning to FIG. 2, if at block 215 of flowchart 200, a determination is made that the pinch gap is not visible, then the flowchart 200 concludes at block 220, where UI activation is blocked. According to some embodiments a UI component may be configured to be revealed when a hand is determined to be in a palm up position. However, a handmade and intentionally be in a palm up position when a user is manipulating an object or otherwise naturally moving their hand. Accordingly, by blocking these are input activation when the pinch gap is not visible allows the system to reject hand poses common withholding objects, and uncommon for intentionally performing a palm-up input gesture.

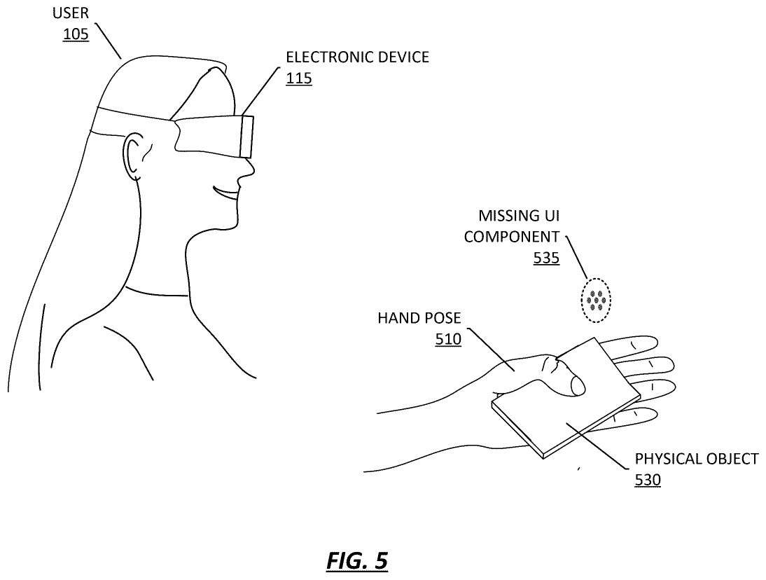

Turning to FIG. 5, an example diagram of a user performing an alternate hand pose is presented, in accordance with one or more embodiments. In particular, FIG. 5 shows the user 105 using the electronic device 115 within a physical environment. In the example shown, user 105 has their hand in hand pose 510, in a palm-up position while holding a physical object 530. Accordingly, the UI component is not activated, as shown by missing UI component 535.

Because hand tracking relies on the position and geometric characteristics of the different portions of the hand, input gestures may be detected when they are performed unintentionally, such as when a person performs a hand pose in the context of interacting with an object. Thus, the hand pose 510 may be falsely identified to be a palm-up input pose based on the hand pose 510. However, the user 105 is holding the physical object 530 in such a manner than the thumb is overlaying the palm, which would not be a pose typically associated with a palm-up input gesture, and more typically associated with a user holding an object.

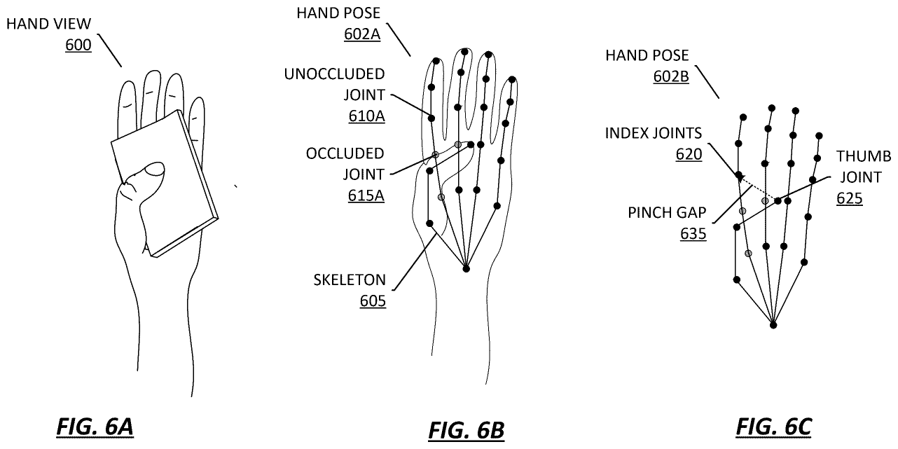

FIGS. 6A, 6B, and 6C depict example diagrams of hand tracking data from which pinch gap visibility is determined, in accordance with one or more embodiments. In particular, FIGS. 6A, 6B, and 6C depict example hand tracking data of a hard performing a pose similar to the pose shown above with respect to FIG. 5. FIG. 6A shows a view of a hand 600 as it may be captured by a camera, such as a camera of an image capture system of an electronic device. According to one or more embodiments, the view of the hand 600 may be captured from an electronic device from a perspective of the user, such as a head mounted device or other wearable device having an image capture system, or other image capture device positioned such that the hand view can be captured.

FIG. 6B shows a diagram of example hand tracking data in the form of a skeleton 605. The skeleton 605 may include a collection of joints tracked by a hand tracking system. In some embodiments, the hand tracking system may determine location information for each joint in the hand. In some embodiments, hand pose 602A may be determined based on geometric characteristics of the skeleton 605.

According to one or more embodiments, the hand tracking system may provide an occlusion score for each joint in the hand. In the example shown, occluded joint 615A is a joint in a palm at the base of the index finger that is occluded by the upper portion of the thumb, and is represented by a gray circle. Unoccluded joint 610A represents a joint toward the top of the index finger, which is not occluded, and is represented by a black circle. In some embodiments, the image capture system may include a stereo camera or other multi camera system, in which at least some hand tracking data may be determined for each camera. For example, an occlusion score may be determined for each camera because whether the joint location is occluded will differ based on the camera position of each camera, whereas location information may be determined for each camera, or may be determined based on the combination of image data captured from the cameras. The occlusion score may be a Boolean value indicating whether or not the joint is occluded, or may be a value indicating a confidence value that the joint is occluded, or representing how occluded the joint is, such as when the joint is partially occluded.

As described above with respect to FIG. 2, in determining whether a hand is in an object-occluded pose, an initial determination may be made as to the visibility of the gap distance. As shown in FIG. 6C, the pinch gap 635 represents the distance between thumb joint 625 and the index finger in hand pose 602B. For example, a gap distance for the pinch gap 635 may be determined based on a distance between the thumb joint 625 at the tip of the thumb and one of the index joints 620. Alternatively, the gap distance 635 may be determined based on a distance between the thumb joint 625 and a bone of the index finger, which may be derived from the index joints 620. As described above, in some embodiments, the pinch gap is determined to be visible by projecting the perpendicular projection vector from the hover vector (between the thumb tip and index fingertip) onto the camera plane. In addition, a direction of the pinch gap may cause the gap distance to be determined as a positive or negative value. Here, because the gap distance of the pinch gap 635 is fairly large, but the thumb is inside the index finger, the gap distance may be determined to be a negative value, and thus not considered to be visible. Thus, returning to FIG. 2, a determination may be made at block 215 that the pinch gap is not visible, and the flowchart 200 may conclude at block 220 where the UI activation is blocked. Notably, the UI activation is blocked without regard for UI context or index finger occlusion values, thereby simplifying the determination.

### State Transitions

According to one or more embodiments, the determination of whether the hand is in a pose considered to likely be occluded by an object may be tracked by an occlusion determination state machine. The determination may be based on index finger occlusion values as well as a current UI context.

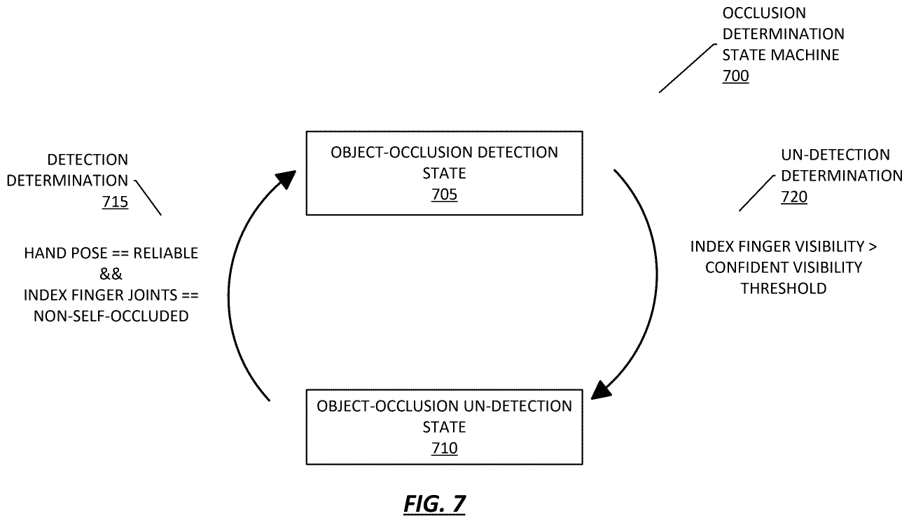

FIG. 7 depicts an example state machine for determining object-occlusion detection state, in accordance with one or more embodiments. In particular, FIG. 7 depicts an occlusion determination state machine 700 for the parameters considered for transitioning a hand from an object-occlusion detection state 705 (that is, a state in which the hand is determined to be interacting with an object), and an object-occlusion un-detection state 710 (that is, a state in which the hand pose is no longer determined to be interacting with an object).

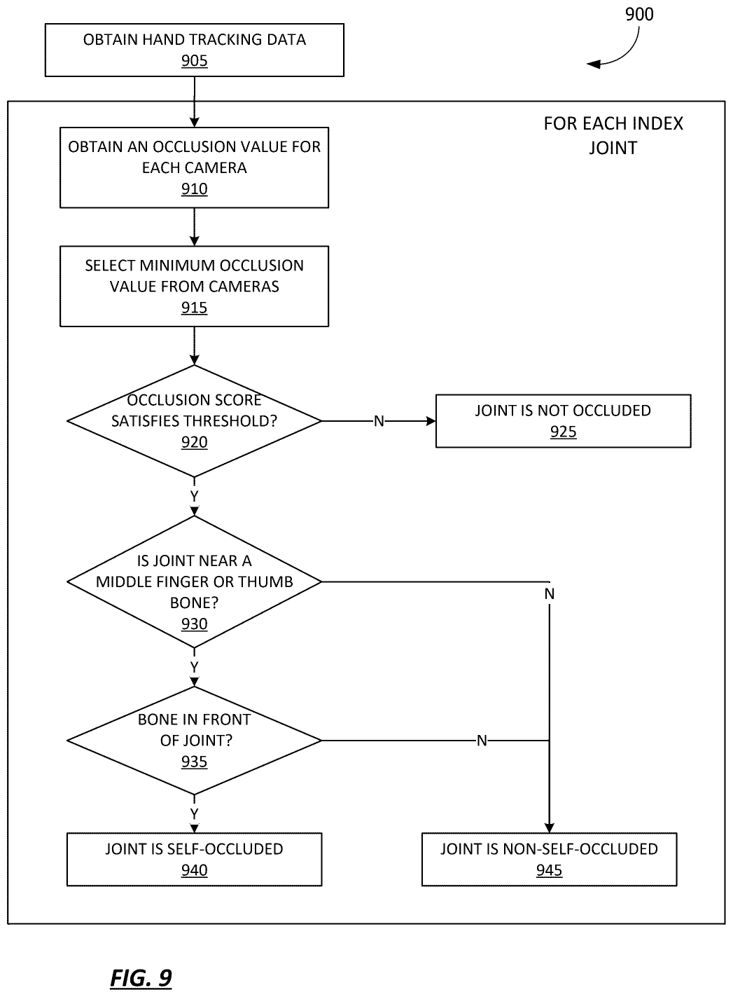

Generally, from an object-occlusion detection state 705, a detection determination 715 may be made based on a determination that parts of the index finger are occluded by something else (i.e., the index finger is non-self-occluded) while the hand pose is reliable. As will be described in greater detail below, with respect to FIG. 10, a reliability determination may be made based on a palm position and pinch gap visibility. Further, in some embodiments, the reliability of a pose may be based on whether a hand is sufficiently stationary. Thus, a reliable pose may be characterized by a stable hand with a visible pinch gap while the hand is facing the camera. In some embodiments, whether the hand transitions from an object-occlusion detection state 705 to an object-occlusion un-detection state 710 may be further based on a current UI context. For example, if a UI is currently active, a confidence in the reliability of the hand pose and the visibility of the non-self-occluded index finger joints may be required to satisfy a stability metric prior to dismissing the active UI. By contrast, if the UI is currently inactive, a stability metric may not be considered.

In some embodiments, transitioning from the object-occlusion un-detection state 710 to the object-occlusion detection state 705 may be made based on a determination that the index finger is very visible. In particular, an un-detection determination 720 may be based on a comparison of index finger visibility to a confidence threshold. In some embodiments, the determination may be based on identifying a maximum occlusion score among the index finger occlusion values, and comparing the maximum occlusion score to a predefined occlusion threshold. Accordingly, the un-detection determination does not rely on identifying whether individual joints are non-self-occluded. In some embodiments, the un-detection determination 720 may indicate that the hand is not likely interacting with an object, and therefore is more likely to be intentionally performing an input gesture. Thus, a UI component may be revealed in accordance with the un-detection determination 720.

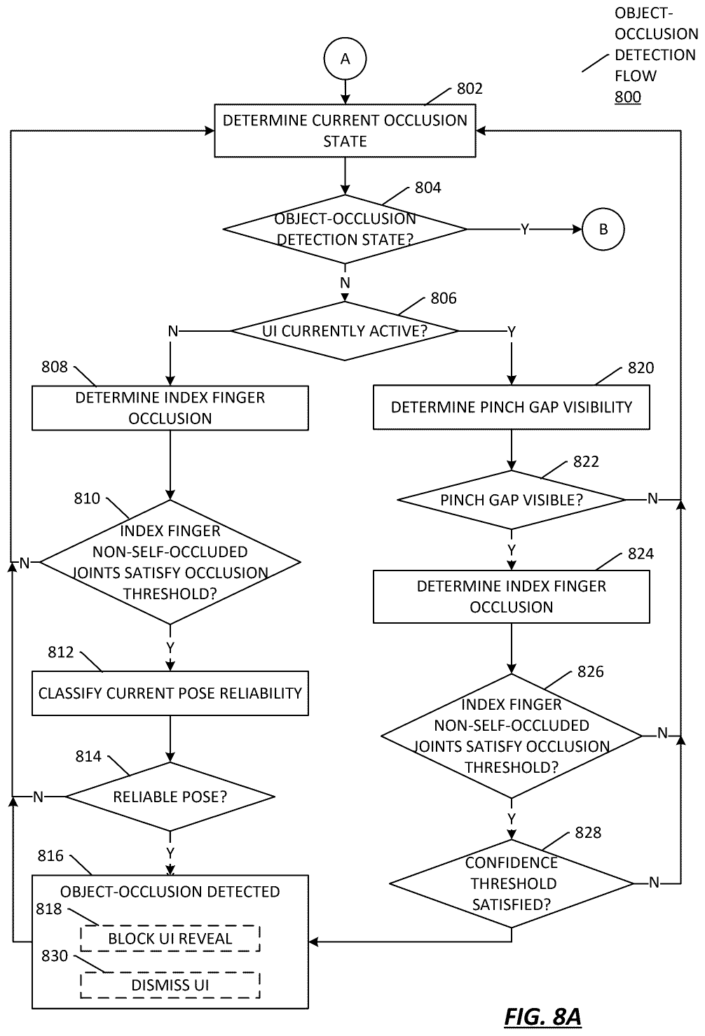

FIGS. 8A-8B depict flowcharts of techniques for transitioning between an object-occlusion detection state and an object-occlusion un-detection state, in accordance with one or more embodiments. In particular, the flowcharts depict an example technique for determine whether a hand is in an object-occluded pose. For purposes of explanation, the following steps will be described as being performed by particular components. However, it should be understood that the various actions may be performed by alternate components. The various actions may be performed in a different order. Further, some actions may be performed simultaneously, and some may not be required, or others may be added.

FIG. 8A depicts an object occlusion detection flow 800. The flowchart begins at block 802, where a current occlusion state is determined. As described above, occlusion states may include an object-occlusion detection state and an object-occlusion un-detection state. The object-occlusion detection state may indicate that oppose of the hand indicates that the hand is likely occluded by a physical object, such as when the hand is holding an object. The object-occlusion un-detection in state corresponds to a state in which the hand pose no longer indicates that the hand is occluded by a physical object.

At block 804, a determination is made as to whether the hand is currently in the object-occlusion detection state. If the determination is made that the hand is not in an object-occlusion detection state (for example, if the hand isn't an object occlusion under detection state) then the flowchart proceeds to block 806. At block 806, a determination is made as to whether a UI component is currently active. The UI component may be associated with the particular input pose being detected, such as a palm up pose. A UI component may be active, for example, if it is presented on a display, and/or corresponding processes for the UI component are executing.

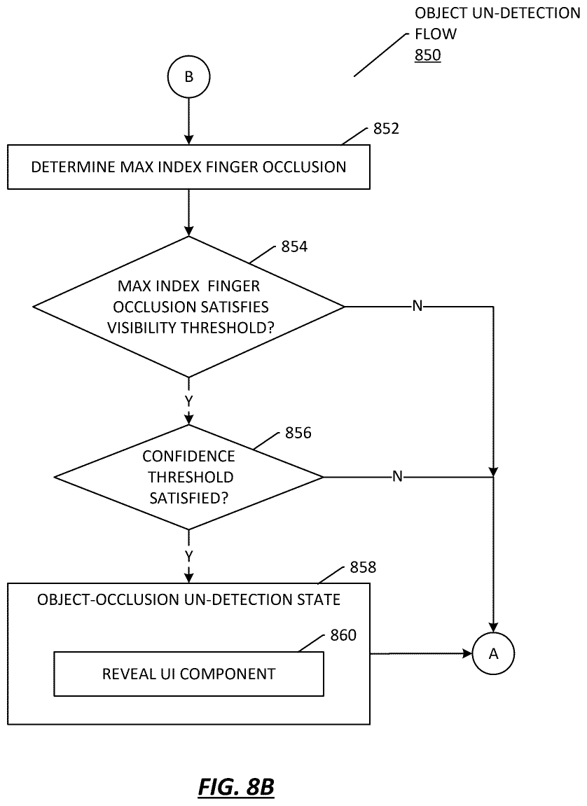

If at block 806, a determination is made that the UI component is not currently active, then the flowchart proceeds to block 808. At block 808, index finger occlusion is determined. Determining index finger occlusion may include determining occlusion values for different portions of the index finger, such as different joints of the index finger. As described above, the occlusion values where the index finger may be obtained from a hand tracking process. And some embodiments, index finger occlusion they include determinations as to whether particular portions of the index finger are occluded by other portions of the hand. For example, included joints may be classified as self-occluded joints when the joints are being occluded by another portion of the hand. Joints may be classified as non-self-occluded joints when the joints are occluded but not by the hand. The process for determining index finger occlusion will be explained in greater detail below with respect to FIG. 9.

Returning to FIG. 8A, the flowchart proceeds to block 810, where a determination is made as to whether portions of the index finger satisfying the occlusion threshold. In particular, a determination is made as to whether the non-self-occluded joints satisfy an occlusion threshold. For example, the occlusion values of the joints determined to be non-self-occluded can be compared against a threshold occlusion value to determine whether the joint satisfied the occlusion threshold. If the non-self-occluded joints fail to satisfy the occlusion threshold, then the flowchart returns to block 802, and the hand remains in an object-occlusion un-detection state.

If at block 810 the non-self-occluded joints satisfies the occlusion threshold, then the flowchart proceeds to block 812, and a current pose reliability of the hand is classified. In particular, the pose of the hand is analyzed to determine how reliable the pose is for predicting whether it be hand is occluded by an object period and somebody must column pose reliability may be dependent upon an orientation of the palm of the hand with respect to the camera, such as the palm facing the camera, pinch gap visibility, and stability of the hand. In some embodiments, the reliability of the pose may additionally or alternatively be determined based on gaze information, for example in determining that the user is looking at a direction toward the hand. The reliability determination will be described in greater detail below with respect to FIG. 10.

Returning to FIG. 8A, in the flowchart proceeds to block 814, where determination made as to the reliability of the post. If that block 814 the pose is determined to not be reliable, then the flowchart returns to block 802, and the hand remains in an object-occlusion un-detection state. Alternatively, if at block 814, the pose is determined to be reliable, and the flowchart proceeds to Block 816 and the hand transitions to an object occlusion detection pose. In addition, at block 818, a UI component associated with the gesture is blocked from being revealed. The flowchart then returns to block 802.

Returning to block 806, if UI component is currently active, then the flowchart proceeds to block 820. At block 820, pinch gap visibility is determined. Pinch gap visibility may indicate whether a gap distance is sufficiently visible from the camera. Pinch gap visibility may be determined in a number of ways, for example using the technique described above with respect to FIG. 3. If at block 822 the pinch gap is determined to not be visible, then the flowchart returns to block 802, and the hand remains in an object-occlusion un-detection state.

Returning to block 822, if the pinch gap is visible, then the flowchart proceeds to block 824. At block 824, index finger occlusion is determined. Determining index finger occlusion may include determining occlusion values for different portions of the index finger, such as different joints of the index finger. As described above, the occlusion values where the index finger may be obtained from a hand tracking process. In some embodiments, index finger occlusion may include a determination as to whether particular portions of the index finger are occluded by other portions of the hand. For example, included joints may be classified as self-occluded joints when the joints are being occluded by another portion of the hand. Joints may be classified as non-self-occluded joints when the joints are occluded but not by the hand. The process for determining index finger occlusion will be explained in greater detail below with respect to FIG. 9.

Returning to FIG. 8A, the flowchart proceeds to block 826, where a determination is made as to whether portions of the index finger satisfy an occlusion threshold. In particular, a determination is made as to whether the non-self-occluded joints satisfy an occlusion threshold. For example, the occlusion values of the joints determined to be non-self-occluded can be compared against a threshold occlusion value to determine whether the joint satisfied the occlusion threshold. The occlusion threshold used at block 826 may be the same or different than the occlusion threshold used at block 810. If the non-self-occluded joints fail to satisfy the occlusion threshold, then the flowchart returns to block 802, and the hand remains in an object-occlusion un-detection state.

Alternatively, if at block 826 the index finger non-self-occluded joints satisfy the occlusion threshold, then the flowchart proceeds to block 828. At 828, a determination is made as to whether a confidence threshold is satisfied. In some embodiments, the confidence threshold may indicate a time period or number of frames for which the pinch gap is visible, and the occlusion value of non-self-occluded joints is high prior to transitioning to the object-occlusion-detection state. Thus, if at block 828, the confidence threshold is not satisfied, then the flowchart returns to block 802, and the hand remains in an object-occlusion un-detection state. In addition, the UI component remains active. If at block 828, the confidence threshold is satisfied, then the flowchart proceeds to block 816 and the hand transitions to an object occlusion detection pose. In addition, at block 830, the active UI component is dismissed. The flowchart then returns to block 802.

If at block 804, a determination is made that the hand is in an object-occlusion detection state, then the flowchart proceeds to the object un-detection flow 850 of FIG. 8B. According to one or more embodiments, object undetected flow 850 is used to determine when a hand should transition from an object-occlusion detection state to an object occlusion on detection state.

The flowchart begins at block 852, where a maximum index finger occlusion value is determined. In some embodiments, an occlusion value is obtained for each camera, for a particular joint. In some embodiments, a particular joint may have different occlusion scores when captured by different cameras simultaneously because of different viewpoints of the camera. Accordingly, the occlusion values for a particular joint from different cameras may be the same or may differ. A maximum occlusion value may be determined across all index finger joints, and/or from all camera views. The maximum occlusion value may therefore indicate the least visible portion of the index finger.

The flowchart proceeds to block 854, where determination is made as to whether the maximum index finger occlusion value satisfies a visibility threshold. The visibility threshold baby a threshold occlusion value indicating that the finger is sufficiently visible. For example, the determination may be made as to whether the maximum index finger occlusion value is below the visibility threshold occlusion value, therefore indicating that the finger is sufficiently unoccluded. If a determination is made that the maximum finger occlusion value fails to satisfy the visibility threshold, then the flowchart returns to the object-occlusion detection flow 800 of FIG. 8A, and the hand remains in the object-occlusion detection state.

Returning to FIG. 8B, if at block 854 the determination is made that the maximum index finger occlusion satisfies the visibility threshold, then the flowchart proceeds to block 856. At block 856, a determination is made as to whether a confidence threshold is satisfied. In some embodiments, the confidence threshold may indicate a time period or number of frames for which the max index finger occlusion value satisfies the visibility threshold. Thus, if at block 856, the confidence threshold is not satisfied, then the flowchart returns to the object-occlusion detection flow 800 of FIG. 8A, and the hand remains in the object-occlusion detection state. In addition, a UI component associated with the hand gesture is not activated or revealed.

Returning to block 856, if the confidence threshold is satisfied, then the flowchart concludes at block 858, and the hand transitions to an object-occlusion un-detection state. In addition, at block 860, a UI component associated with the gesture is revealed. That is, the entire index finger must be very visible to transition from the object-occlusion detection state to the object-occlusion un-detection state, in accordance with one or more embodiments.

### Index Finger Occlusion Determination

According to some embodiments, transitioning from an object-occlusion un-detection state to an object-occlusion detection state involves determining occlusion values for non-self-occluded index joints. To that end, a determination may be made for each joint of the index finger as to whether the joint is self-occluded. FIG. 9 depicts a flowchart of an example technique for determining index finger joint occlusion, in accordance with one or more embodiments. For purposes of explanation, the following steps will be described as being performed by particular components. However, it should be understood that the various actions may be performed by alternate components. The various actions may be performed in a different order. Further, some actions may be performed simultaneously, and some may not be required, or others may be added.

The flowchart 900 begins at block 905 where hand tracking data is obtained. According to one or more embodiments, hand tracking data is obtained from one or more camera frames or other frames of sensor data. According to one or more embodiments, the hand tracking data may include image data and/or depth data. The hand tracking data may be obtained from one or more cameras, including stereoscopic cameras or other multi camera image capture systems. In some embodiments, the hand tracking data may include sensor data captured by outward facing cameras of a head mounted device. The hand tracking data may be obtained by applying the sensor data to a hand tracking network or other computing module which generates hand tracking data. According to one or more embodiments, the hand tracking data may include location information for each joint, an occlusion score for each joint, a hand pose based on the configuration of the joint locations, or the like.

The flowchart proceeds to blocks 910-945, which are performed on a per-joint basis for the index finger joints. Generally, blocks 910-945 present a technique for determining whether each index finger joint is self-occluded or non-self-occluded. At block 910, an occlusion value is obtained for each camera, for a particular index joint. In some embodiments, a particular joint may have different occlusion scores when captured by different cameras simultaneously because of different viewpoints of the camera and/or different hand pose configurations. Accordingly, the occlusion values for a particular joint from different cameras may be the same or may differ.

The flowchart proceeds to block 915, where a minimum occlusion value is selected from the occlusion values obtained at block 910 for a particular joint. Said another way, an occlusion value corresponding to the most visible value from the set of occlusion values is selected. Accordingly, because the determination is performed per joint, an occlusion value for one joint may be selected from a first camera frame captured by the first camera of a multi camera system, whereas an occlusion value for a second joint may be selected from a second camera frame captured by a second camera of a multi-camera system.

The flowchart 900 proceeds to block 920, where a determination is made as to whether the particular joint is at least partially occluded. The joint may be at least partially occluded, for example, if the minimum occlusion value from block 915 is a non-zero value. The determination as to whether the particular joint is at least partially occluded is determined based on the minimum occlusion score selected at block 915. Because the minimum occlusion value corresponds to a most visible view of the joint, the occlusion determination at block 920 only needs to rely on the selected minimum occlusion value. If at block 920, the particular joint is not at least partially occluded, then the flowchart concludes at block 925 and the joint is determined to not be occluded.

Returning to block 920, if a determination is made that the particular joint is at least partially occluded, then the flowchart proceeds to block 930, and a determination is made as to whether the particular joint is near a middle finger or thumb, such as a joint or bone from the middle finger or thumb. In some embodiments, the determination may be made by determining whether any portion of the middle finger or thumb is within a threshold distance of the index finger joint. If a determination is made that the joint is not near the middle finger or thumb, then the flowchart concludes at block 945, and the joint is determined to be non-self-occluded.

Returning to block 930, if the joint is determined to be near a portion of the middle finger or thumb, then the flowchart proceeds to block 935. At block 935, a determination is made as to whether the portion of the thumb or middle finger is in front of the particular joint, for example, if a bone from the thumb or middle finger is in front of the particular joint along the camera's line of sight. In some embodiments, determining whether the bone is in front of the joint may include determining whether the bone is at least a threshold distance closer to the camera than the particular joint. Said another way, the bone may have to be at least a threshold distance closer to the camera than the joint, as well as being in front of the joint from the perspective of the camera. If the determination is made that the bone is not in front of the particular joint, then the flowchart concludes at block 945, and the joint is determined to be non-self-occluded. Alternatively, returning to block 935, if the bone is determined to be in front of the joint and, optionally, satisfies a threshold distance closer to the camera than the joint, then the flowchart 900 concludes at block 940 and the joint is determined to be self-occluded.

### Reliable Pose Determination

According to one or more embodiments, blocking a UI reveal may involve determining that a hand pose is reliable. FIG. 10 depicts a flowchart of the example technique for determining hand pose reliability, in accordance with more one or more embodiments. For purposes of explanation, the following steps will be described as being performed by particular components. However, it should be understood that the various actions may be performed by alternate components. The various actions may be performed in a different order. Further, some actions may be performed simultaneously, and some may not be required, or others may be added.

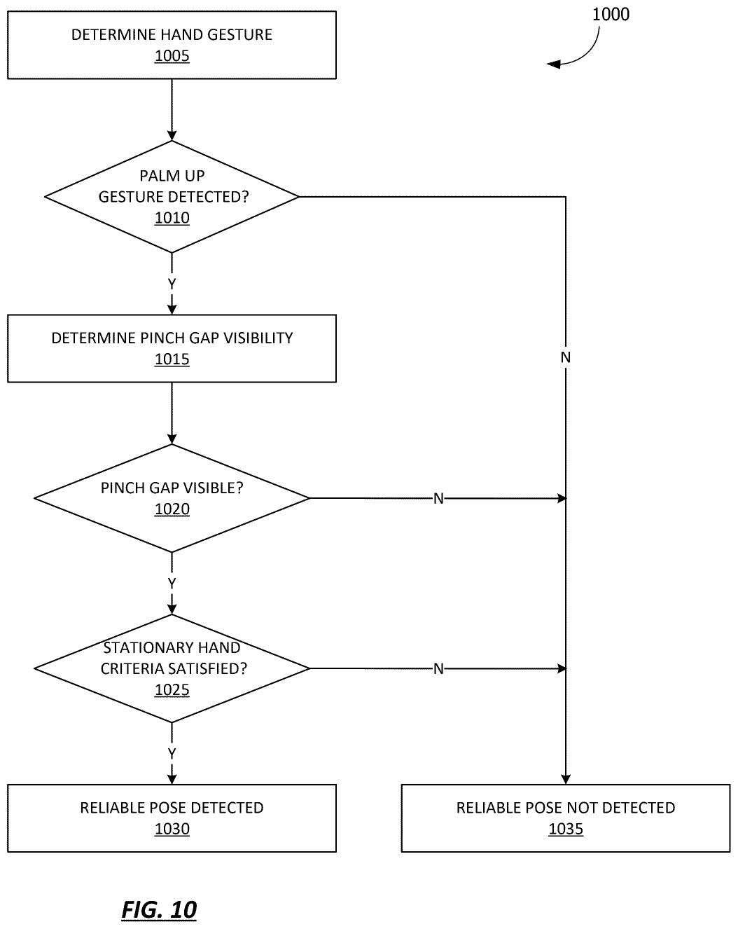

The flowchart 1000 begins at block 1005 where a hand gesture is determined. According to one or more embodiments, determining the gesture may include determining whether the hand is in a palm-up input pose based on hand orientation and gaze direction. Turning to FIG. 11, a flowchart of an example technique for determining whether the hand is in a palm-up input pose is depicted, in accordance with some embodiments.

The flowchart 1100 begins at block 1105, tracking data is captured of a user. According to some embodiments, tracking data is obtained from sensors on an electronic device, such as cameras, depth sensors, or the like. The tracking data may include, for example, image data, depth data, and the like, from which pose, position, and/or motion can be estimated. For example, location information for one or more joints of a hand can be determined from the tracking data, and used to estimate a pose of the hand. According to one or more embodiments, the tracking data may include position information, orientation information, and or motion information for different portions of the user.

In some embodiments, the tracking data may include or be based on additional sensor data, such as image data and/or depth data captured of a user's hand or hands in the case of hand tracking data, as shown at block 1110. In some embodiments, the sensor data may be captured from sensors on an electronic device, such as outward-facing cameras on a head mounted device, or cameras otherwise configured in an electronic device to capture sensor data including a user's hands. Capturing tracking data may also include, at block 1115, obtaining head tracking data. In some embodiments, the sensor data may include position and/or orientation information for the electronic device from which location or motion information for the user can be determined. According to some embodiments, a position and/or orientation of the user's head may be derived from the position and/or orientation data of the electronic device when the device is worn on the head, such as with a headset, glasses, or other head mounted device.

In some embodiments, capturing tracking data of a user may additionally include obtaining gaze tracking data, as shown at block 1120. Gaze may be detected, for example, from sensor data from eye tracking cameras or other sensors on the device. For example, a head mounted device may include inward-facing sensors configured to capture sensor data of a user's eye or eyes, or regions of the face around the eyes which may be used to determine gaze. For example, a direction the user is looking may be determined in the form of a gaze vector. The gaze vector may be projected into a scene that includes physical and virtual content.

The flowchart 1100 proceeds to block 1125, where geometric characteristics are determined of the hand relative to the head. In some embodiments, the geometric characteristics may include a relative position and/or orientation of the hand (or point in space representative of the hand) and the head (or point in space representative of the head). At block 1130, a determination is made as to whether the hand is facing the head. For example, position and/or orientation information for a palm and a head, and/or relative positioning of the palm and the head may be used to determine whether a palm is mostly facing toward the head or camera, thereby being in a palm-up position. Thus, if the hand is not facing the head, then the flowchart conclude at block 1145, and the hand is determined to not be in a palm up position.

Returning to block 1130, if the hand is determined to be facing the head, then the flowchart 1100 proceeds to block 1135. At block 1135, a determination is made as to whether gaze criteria is satisfied. According to one or more embodiments, while hand pose is determined irrespective of gaze, a gaze vector may be considered in determining a gesture state. In particular, a gaze vector may be identified and used to determine whether a gaze criterion is satisfied. Generally, a gaze criterion may be satisfied if a target of the gaze is directed to a region of interest, such as a region around a hand performing a gesture, or a portion of the environment displaying a virtual component, or where a virtual component is to be displayed.

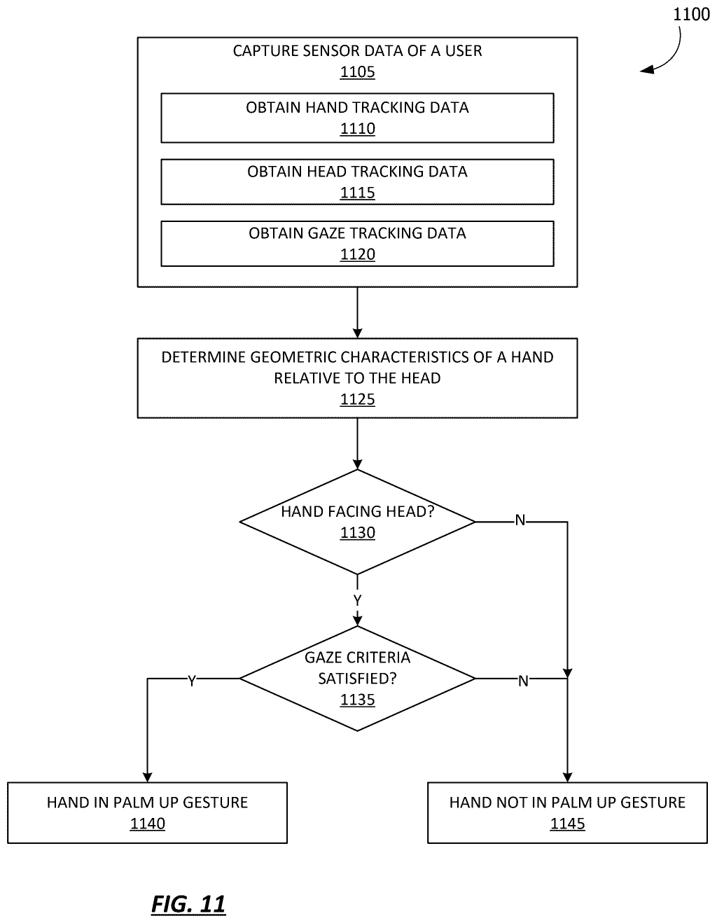

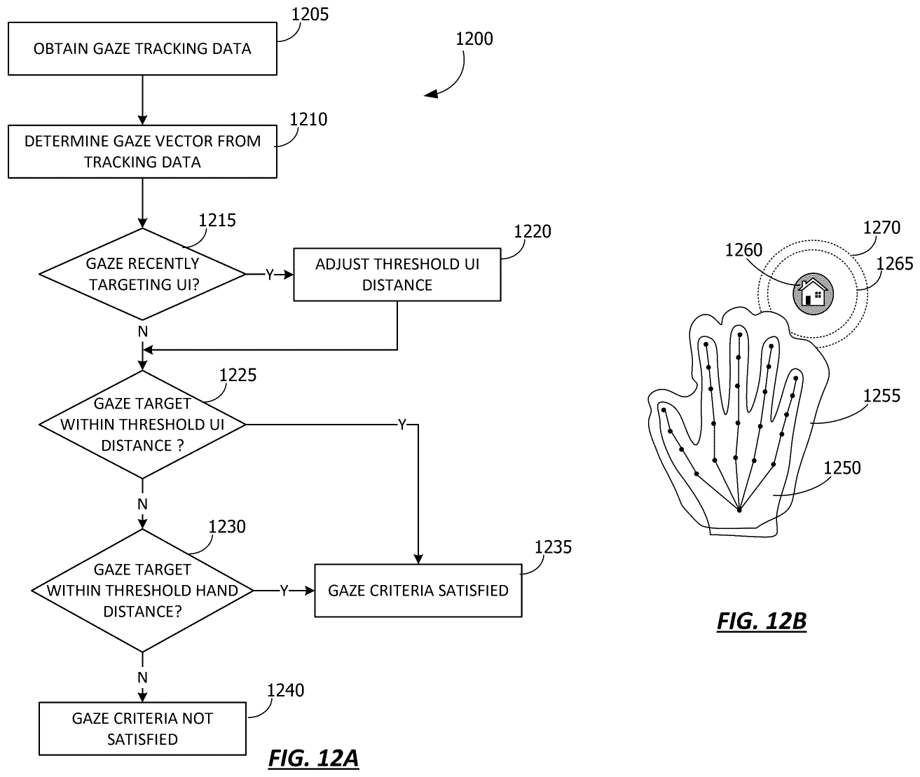

FIG. 12A shows a flowchart of a technique for determining whether a gaze criterion is satisfied, in accordance with one or more embodiments. For purposes of explanation, the following steps will be described as being performed by particular components. However, it should be understood that the various actions may be performed by alternate components. The various actions may be performed in a different order. Further, some actions may be performed simultaneously, and some may not be required, or others may be added.

The flowchart 1200 begins at block 1205, where gaze tracking data is obtained. For example, an eye tracking system may include one or more sensor is configured to capture image data or other sensor data from which the viewing direction of eye can be determined. The flowchart 1200 proceeds to block 1210, where a gaze vector is obtained from gaze tracking data. According to one or more embodiments, the gaze vector may be obtained from gaze tracking data, such as inward facing cameras on a head mounted device or other electronic device facing the user. A gaze tracking system may include one or more sensor is configured to capture image data or other sensor data from which the viewing direction of eye can be determined.

At block 1215, a determination is made as to whether a gaze was recently targeting a user interface component. This may occur, for example, when a most recent instance of a gaze vector intersecting a UI component region occurred within a threshold time period, such as if a user momentarily looked away. A gaze target is determined from the gaze vector. If the gaze was targeting the UI within the threshold time period, the flowchart proceeds to block 1220, and the threshold UI distance is adjusted. For example, if a user looks away, a UI region may be narrowed such that the gaze make criteria becomes stricter. In the example shown in FIG. 12B, a target region may be associated with UI component 1260. The target region may surround the UI component 1260, and/or may be based on the location where the UI component is to be presented, such as an anchor position for the UI component. This may occur, for example, if the UI component is to be presented based on a location of another component in the environment, such as the fingertips of the hand, a physical object in the environment, or the like. The target region around the UI component may shrink from region 1270 to region 1265 during the time period.

After the threshold UI distance is adjusted at block 1220, or if a determination was made at block 1215 that the gaze was not recently targeting the UI component, then the flowchart 1200 proceeds to block 1225 and a determination is made as to whether the gaze target is within the threshold UI distance. As shown in FIG. 12B, the threshold UI distance may either within region 1265 or region 1270, depending upon whether the threshold UI distance was adjusted at block 1220. If a determination is made that the gaze target is within a current threshold UI distance of the UI component, then the flowchart concludes at block 1235, and the gaze criteria is considered to be satisfied.

Returning to block 1225, if a determination is made that the gaze target is not within the threshold UI distance, then the flowchart 1200 proceeds to block 1230, where a determination is made as to whether the gaze target is within a threshold hand distance. With respect to the hand 1250 of FIG. 12B, the hand region 1255 may be determined in a number of ways. For example, a geometry of the hand or around the hand may be determined in the image data, and may be compared against a gaze vector. As another example, a skeleton of the hand may be obtained using hand tracking data, and a determination may be made as to whether the gaze falls within a threshold location of the skeleton components for which location information is known. As an example, the hand region 1255 may be defined as a region comprised of a bone length distance around each joint location, creating a bubble shape. If a determination is made that the gaze target is within the threshold hand distance, then the flowchart concludes at block 1235, and the gaze criterion is determined to be satisfied. However, if a determination is made at block 1230 that the gaze target is not within a threshold hand distance, such as hand region 1255, the flowchart concludes at block 1240 and the gaze criteria is determined to not be satisfied.

Returning to FIG. 11, if at block 1135, a determination is made that the gaze criteria is satisfied, then the flowchart 1100 conclude at block 1140, and the hand is considered to be in a palm up gesture. By contrast, if at block 1135 a determination is made that the gaze criteria is not satisfied, then the flowchart 1100 concludes at block 1145 and the hand is determined to not be in a palm up gesture.

Returning yet again to FIG. 10, a determination is made at block 1010 as to whether a palm up gesture is detected. If the palm-up gesture is not detected, then the flowchart 1000 concludes at block 1035 and the pose is determined to not be reliable.

Returning to block 1010, if a palm-up gesture is detected, then the flowchart proceeds to block 1015 and pinch gap visibility is determined. As described above with respect to FIG. 3, pinch gap visibility may indicate whether a threshold distance between the thumb tip and the index finger bone is visible from the perspective of one or more of the cameras capturing the image data of the hand used for hand tracking, and whether the thumb is outside the hand. If at block 1020, the pinch gap is determined to not be visible, then the flowchart 1000 concludes at block 1035 and the pose is determined to not be reliable.

If at block 1020 the pinch gap is determined to be visible, then the flowchart 1000 proceeds to block 1025 and a determination is made as to whether stationary hand criteria is satisfied. The stationary hand criteria may indicate that the hand is not rotating for a predefined amount of time. The determination may be made based on hand tracking data for one or more joints of the hand. If the stationary hand criteria is not satisfied, then the flowchart 1000 concludes at block 1035 and the pose is determined to not be reliable. Alternatively, if the stationary hand criteria is satisfied, then the flowchart concludes at block 1030 and the hand is determined to be in a reliable pose.

### Example Electronic Device and Related Components

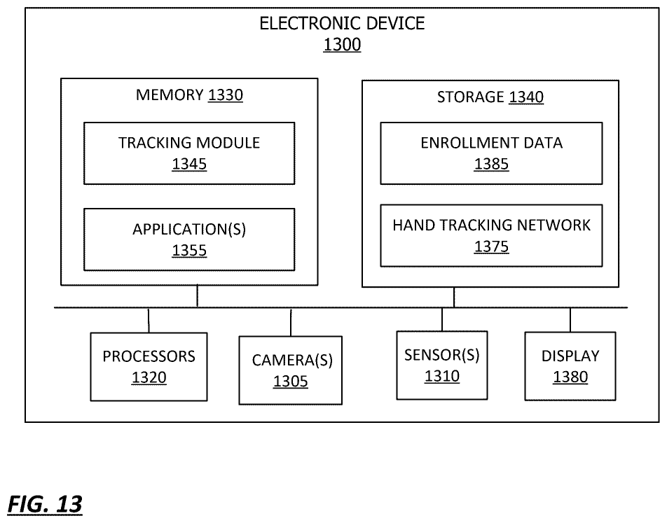

Referring to FIG. 13, a simplified block diagram of an electronic device 1300 is depicted. Electronic device 1300 may be part of a multifunctional device, such as a mobile phone, tablet computer, personal digital assistant, portable music/video player, wearable device, head-mounted systems, projection-based systems, base station, laptop computer, desktop computer, network device, or any other electronic systems such as those described herein. Electronic device 1300 may include one or more additional devices within which the various functionality may be contained or across which the various functionality may be distributed, such as server devices, base stations, accessory devices, etc. Illustrative networks include, but are not limited to, a local network such as a universal serial bus (USB) network, an organization's local area network, and a wide area network such as the Internet. According to one or more embodiments, electronic device 1300 is utilized to interact with a user interface of an application 1355. It should be understood that the various components and functionality within electronic device 1300 may be differently distributed across the modules or components, or even across additional devices.

Electronic Device 1300 may include one or more processors 1320, such as a central processing unit (CPU) or graphics processing unit (GPU). Electronic device 1300 may also include a memory 1330. Memory 1330 may include one or more different types of memory, which may be used for performing device functions in conjunction with processor(s) 1320. For example, memory 1330 may include cache, ROM, RAM, or any kind of transitory or non-transitory computer-readable storage medium capable of storing computer-readable code. Memory 1330 may store various programming modules for execution by processor(s) 1320, including tracking module 1345, and other various applications 1355. Electronic device 1300 may also include storage 1340. Storage 1340 may include one more non-transitory computer-readable mediums including, for example, magnetic disks (fixed, floppy, and removable) and tape, optical media such as CD-ROMs and digital video disks (DVDs), and semiconductor memory devices such as Electrically Programmable Read-Only Memory (EPROM) and Electrically Erasable Programmable Read-Only Memory (EEPROM). Storage 1330 may be utilized to store various data and structures which may be utilized for storing data related to hand tracking and UI preferences. Storage 1340 may be configured to store hand tracking network 1375 according to one or more embodiments. Storage 1340 may additionally include enrollment data 1385, which may be used for personalized hand tracking. For example, enrollment data may include physiological characteristics of a user such as hand size, bone length, and the like. Electronic device may additionally include a network interface from which the electronic device 1300 can communicate across a network.

Electronic device 1300 may also include one or more cameras 1305 or other sensors 1310, such as a depth sensor, from which depth of a scene may be determined. In one or more embodiments, each of the one or more cameras 1305 may be a traditional RGB camera or a depth camera. Further, cameras 1305 may include a stereo camera or other multicamera system. In addition, electronic device 1300 may include other sensors which may collect sensor data for tracking user movements, such as a depth camera, infrared sensors, or orientation sensors, such as one or more gyroscopes, accelerometers, and the like.

According to one or more embodiments, memory 1330 may include one or more modules that comprise computer-readable code executable by the processor(s) 1320 to perform functions. Memory 1330 may include, for example, tracking module 1345, and one or more application(s) 1355. Tracking module 1345 may be used to track locations of hands and other user motion in a physical environment. Tracking module 1345 may use sensor data, such as data from cameras 1305 and/or sensors 1310. In some embodiments, tracking module 1345 may track user movements to determine whether to trigger user input from a detected input gesture. In doing so, tracking module 1345 may be used to determine occlusion information for the hand. Electronic device 1300 may also include a display 1380 which may present a UI for interaction by a user. The UI may be associated with one or more of the application(s) 1355, for example. Display 1380 may be an opaque display or may be semitransparent or transparent. Display 1380 may incorporate LEDs, OLEDs, a digital light projector, liquid crystal on silicon, or the like.

Although electronic device 1300 is depicted as comprising the numerous components described above, in one or more embodiments, the various components may be distributed across multiple devices. Accordingly, although certain calls and transmissions are described herein with respect to the particular systems as depicted, in one or more embodiments, the various calls and transmissions may be made differently, or may be differently directed based on the differently distributed functionality. Further, additional components may be used, some combination of the functionality of any of the components may be combined.

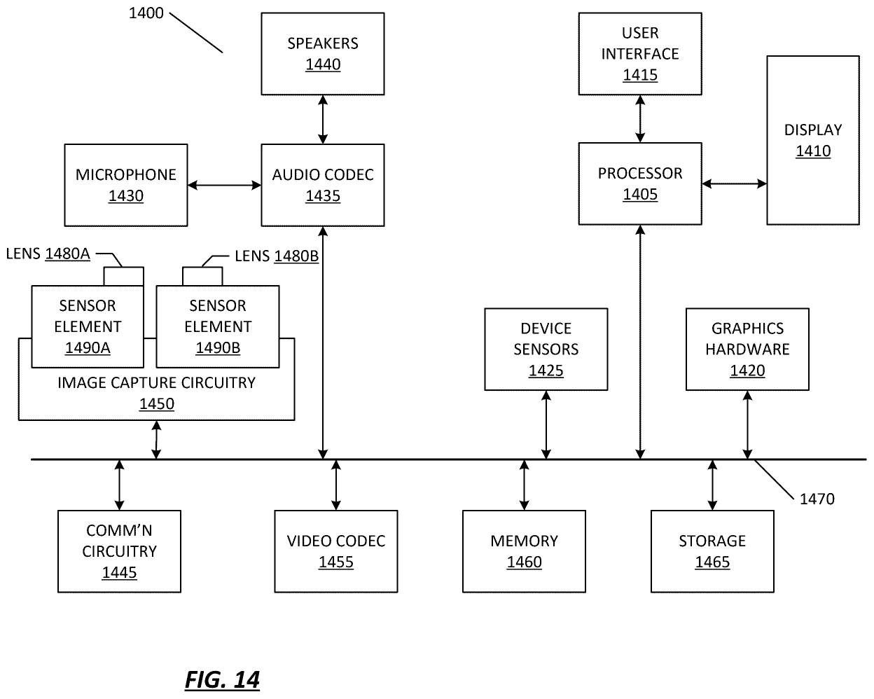

Referring now to FIG. 14, a simplified functional block diagram of illustrative multifunction electronic device 1400 is shown according to one embodiment. Each of electronic devices may be a multifunctional electronic device or may have some or all of the described components of a multifunctional electronic device described herein. Multifunction electronic device 1400 may include processor 1405, display 1410, user interface 1415, graphics hardware 1420, device sensors 1425 (e.g., proximity sensor/ambient light sensor, accelerometer and/or gyroscope), microphone 1430, audio codec(s) 1435, speaker(s) 1440, communications circuitry 1445, digital image capture circuitry 1450 (e.g., including camera system), video codec(s) 1455 (e.g., in support of digital image capture unit), memory 1460, storage device 1465, and communications bus 1470. Multifunction electronic device 1400 may be, for example, a digital camera or a personal electronic device such as a personal digital assistant (PDA), personal music player, mobile telephone, or a tablet computer.

Processor 1405 may execute instructions necessary to carry out or control the operation of many functions performed by device 1400 (e.g., such as the generation and/or processing of images as disclosed herein). Processor 1405 may, for instance, drive display 1410 and receive user input from user interface 1415. User interface 1415 may allow a user to interact with device 1400. For example, user interface 1415 can take a variety of forms, such as a button, keypad, dial, a click wheel, keyboard, display screen, touch screen, gaze, and/or gestures. Processor 1405 may also, for example, be a system-on-chip such as those found in mobile devices and include a dedicated GPU. Processor 1405 may be based on reduced instruction-set computer (RISC) or complex instruction-set computer (CISC) architectures or any other suitable architecture and may include one or more processing cores. Graphics hardware 1420 may be special purpose computational hardware for processing graphics and/or assisting processor 1405 to process graphics information. In one embodiment, graphics hardware 1420 may include a programmable GPU.

Image capture circuitry 1450 may include two (or more) lens assemblies 1480A and 1480B, where each lens assembly may have a separate focal length. For example, lens assembly 1480A may have a short focal length relative to the focal length of lens assembly 1480B. Each lens assembly may have a separate associated sensor element 1490A and 1490B. Alternatively, two or more lens assemblies may share a common sensor element. Image capture circuitry 1450 may capture still and/or video images. Output from image capture circuitry 1450 may be processed by video codec(s) 1455 and/or processor 1405 and/or graphics hardware 1420, and/or a dedicated image processing unit or pipeline incorporated within circuitry 1465. Images so captured may be stored in memory 1460 and/or storage 1465.

Sensor and camera circuitry 1450 may capture still, and video images that may be processed in accordance with this disclosure, at least in part, by video codec(s) 1455 and/or processor 1405 and/or graphics hardware 1420, and/or a dedicated image processing unit incorporated within circuitry 1450. Images so captured may be stored in memory 1460 and/or storage 1465. Memory 1460 may include one or more different types of media used by processor 1405 and graphics hardware 1420 to perform device functions. For example, memory 1460 may include memory cache, read-only memory (ROM), and/or random-access memory (RAM). Storage 1465 may store media (e.g., audio, image, and video files), computer program instructions or software, preference information, device profile information, and any other suitable data. Storage 1465 may include one more non-transitory computer-readable storage mediums including, for example, magnetic disks (fixed, floppy, and removable) and tape, optical media such as CD-ROMs and DVDs, and semiconductor memory devices such as EPROM and EEPROM. Memory 1460 and storage 1465 may be used to tangibly retain computer program instructions, or code organized into one or more modules and written in any desired computer programming language. When executed by, for example, processor 1405 such computer program code may implement one or more of the methods described herein.

Various processes defined herein consider the option of obtaining and utilizing a user's identifying information. For example, such personal information may be utilized in order to track a user's pose and/or motion. However, to the extent such personal information is collected, such information should be obtained with the user's informed consent, and the user should have knowledge of and control over the use of their personal information.

Personal information will be utilized by appropriate parties only for legitimate and reasonable purposes. Those parties utilizing such information will adhere to privacy policies and practices that are at least in accordance with appropriate laws and regulations. In addition, such policies are to be well established and in compliance with or above governmental/industry standards. Moreover, these parties will not distribute, sell, or otherwise share such information outside of any reasonable and legitimate purposes.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health-related applications, data de-identification can be used to protect a user's privacy. De-identification may be facilitated, when appropriate, by removing specific identifiers (e.g., date of birth), controlling the amount or specificity of data stored (e.g., collecting location data at city level rather than at an address level), controlling how data is stored (e.g., aggregating data across users), and/or other methods.

It is to be understood that the above description is intended to be illustrative and not restrictive. The material has been presented to enable any person skilled in the art to make and use the disclosed subject matter as claimed and is provided in the context of particular embodiments, variations of which will be readily apparent to those skilled in the art (e.g., some of the disclosed embodiments may be used in combination with each other). Accordingly, the specific arrangement of steps or actions shown in FIGS. 2-3 and 8-12A, or the arrangement of elements shown in FIGS. 1, 4-7, and 12B-14 should not be construed as limiting the scope of the disclosed subject matter. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein.”

1. A method comprising:
obtaining hand tracking data from one or more cameras of a hand of a user in a pose corresponding to an input gesture, wherein the hand is in a first user interface state when the hand tracking data;
determining pinch gap characteristics corresponding to an index finger of the hand and a thumb of the hand; and
in response to determining that the pinch gap characteristics satisfy a visibility threshold:
determining occlusion characteristics of the index finger,
determining whether the hand is in an object-occlusion detection state or an object-occlusion un-detection state based on the occlusion characteristics of the index finger and the first user interface state, and
adjusting a gesture signal for the input gesture to invoke an action corresponding to the input gesture in accordance with determining whether the hand is in an object-occlusion detection state.

2. The method of claim 1, wherein the action is selected from a group consisting of blocking a reveal of a user interface component, dismissing a user interface component, and revealing a user interface component.

3. The method of claim 1, wherein determining whether the hand is in an object-occlusion detection state or object-occlusion un-detection state comprises:
while the hand is in an object-occlusion un-detection state:
determining non-self-occluded portions of the index finger from the occlusion characteristics,
determining whether the non-self-occluded portions of the index finger satisfy an occlusion threshold, and
transitioning the hand to the object-occlusion detection state based on the non-self-occluded portions of the index finger satisfying the occlusion threshold.

4. The method of claim 3, wherein the hand is further transitioned to the object-occlusion detection state based on a determination that the pose corresponds to a reliable hand pose.

5. The method of claim 4, wherein determining that the pose corresponds to a reliable hand pose comprises:
determining that the pose corresponds to a palm up position; and
determining that the hand satisfies a stationary hand criterion.

6. The method of claim 5, wherein determining that the pose corresponds to a palm up position comprises:
determining that a palm of the hand faces a head of the user; and
determining that a gaze vector of the user satisfies a gaze criterion.

7. The method of claim 1, wherein determining whether the hand is in an object-occlusion detection state or the object-occlusion un-detection state comprises:
while the hand is in an object-occlusion detection state:
determining whether the occlusion characteristics of the index finger satisfy a visibility threshold, and
transitioning the hand to the object-occlusion un-detection state based on the occlusion characteristics of the index finger satisfying the visibility threshold.

8. A non-transitory computer readable medium comprising computer readable code executable by one or more processors to:
obtain hand tracking data from one or more cameras of a hand of a user in a pose corresponding to an input gesture, wherein the hand is in a first user interface state when the hand tracking data;
determine pinch gap characteristics corresponding to an index finger of the hand and a thumb of the hand; and
in response to determining that the pinch gap characteristics satisfy a visibility threshold:
determine occlusion characteristics of the index finger,
determine whether the hand is in an object-occlusion detection state or an object-occlusion un-detection state based on the occlusion characteristics of the index finger and the first user interface state, and
adjust a gesture signal for the input gesture to invoke an action corresponding to the input gesture in accordance with determining whether the hand is in an object-occlusion detection state.

9. The non-transitory computer readable medium of claim 8, wherein the action is selected from a group consisting of blocking a reveal of a user interface component, dismissing a user interface component, and revealing a user interface component.

10. The non-transitory computer readable medium of claim 8, wherein the computer readable code to determine whether the hand is in an object-occlusion detection state or object-occlusion un-detection state comprises computer readable code to:
while the hand is in an object-occlusion un-detection state:
determine non-self-occluded portions of the index finger from the occlusion characteristics,
determine whether the non-self-occluded portions of the index finger satisfy an occlusion threshold, and
transition the hand to the object-occlusion detection state based on the non-self-occluded portions of the index finger satisfying the occlusion threshold.

11. The non-transitory computer readable medium of claim 10, wherein the hand is further transitioned to the object-occlusion detection state based on a determination that the pose corresponds to a reliable hand pose.

12. The non-transitory computer readable medium of claim 11, wherein the computer readable code to determine that the pose corresponds to a reliable hand pose comprises computer readable code to:
determine that the pose corresponds to a palm up position; and
determine that the hand satisfies a stationary hand criterion.

13. The non-transitory computer readable medium of claim 8, wherein the computer readable code to determine whether the hand is in an object-occlusion detection state or the object-occlusion un-detection state comprises computer readable code to:
while the hand is in an object-occlusion detection state:
determine whether the occlusion characteristics of the index finger satisfy a visibility threshold, and
transition the hand to the object-occlusion un-detection state based on the occlusion characteristics of the index finger satisfying the visibility threshold.

14. The non-transitory computer readable medium of claim 8, further comprising computer readable code to:
obtain additional hand tracking data from the one or more cameras;
determine additional pinch gap characteristics corresponding to the index finger of the hand and the thumb of the hand in the additional hand tracking data; and
in response to determining that the additional pinch gap characteristics fail to satisfy the visibility threshold, reject the input gesture.

15. The non-transitory computer readable medium of claim 8, wherein the pinch gap characteristics comprise a distance and direction of a vector from the thumb to the index finger in the hand tracking data.

16. A system comprising:
one or more processors; and
one or more computer readable media comprising computer readable code executable by the one or more processors to:
obtain hand tracking data from one or more cameras of a hand of a user in a pose corresponding to an input gesture, wherein the hand is in a first user interface state when the hand tracking data;
determine pinch gap characteristics corresponding to an index finger of the hand and a thumb of the hand; and
in response to determining that the pinch gap characteristics satisfy a visibility threshold:
determine occlusion characteristics of the index finger,
determine whether the hand is in an object-occlusion detection state or an object-occlusion un-detection state based on the occlusion characteristics of the index finger and the first user interface state, and
adjust a gesture signal for the input gesture to invoke an action corresponding to the input gesture in accordance with determining whether the hand is in an object-occlusion detection state.

17. The system of claim 16, wherein the action is selected from a group consisting of blocking a reveal of a user interface component, dismissing a user interface component, and revealing a user interface component.

18. The system of claim 16, wherein the computer readable code to determine whether the hand is in an object-occlusion detection state or object-occlusion un-detection state comprises computer readable code to:
while the hand is in an object-occlusion un-detection state:
determine non-self-occluded portions of the index finger from the occlusion characteristics,
determine whether the non-self-occluded portions of the index finger satisfy an occlusion threshold, and
transition the hand to the object-occlusion detection state based on the non-self-occluded portions of the index finger satisfying the occlusion threshold.

19. The system of claim 16, further comprising computer readable code to:
obtain additional hand tracking data from the one or more cameras;
determine additional pinch gap characteristics corresponding to the index finger of the hand and the thumb of the hand in the additional hand tracking data; and
in response to determining that the additional pinch gap characteristics fail to satisfy the visibility threshold, reject the input gesture.

20. The system of claim 16, wherein the pinch gap characteristics comprise a distance and direction of a vector from the thumb to the index finger in the hand tracking data.
